(19) United States
(12) Patent Application Publication
(10) Pub. No.: US 2009/0026874 A1
(43) Pub. Date: Jan. 29, 2009

(54) Method for Mounting an Armature Laminated Core on an Armature Shaft and Armature Laminated Core for an Armature Shaft and Armature Shaft with Pressed-On Armature Laminated Core

(76) Inventors: Michael Schmohl, Ammerbuch (DE); Norbert Falter, Neckarhausen (DE)

Correspondence Address: CENTRAL COAST PATENT AGENCY, INC, 3 HANGAR WAY SUITE D, WATSONVILLE, CA, 95076, US

(21) Appl. No.: 11/909,746

(22) PCT Filed: Apr. 30, 2005
(86) PCT No.: PCT/EP2005/004715

§ 371 Date: Sep. 26, 2007

(51) Int. Cl. H02K 1/06; H02K 15/00

(52) U.S. Cl. 310/217; 29/596; 310/272

(57) ABSTRACT

The invention relates to a method for mounting an armature laminated core (6) on an armature shaft (2) for an electric motor, the armature shaft (2) being formed either from electrically insulating solid plastic or being a shaft which is sheathed with an electrically insulating plastic (10), the sheath (8) having a thickness of at least 1 mm, and having the following features: manufacture of armature cores (12) whose central opening (14) for the armature shaft (2) has a non-round cross section with at least one radially inwardly extended projection (20), the diameter of an inscribed circle (22) which forms a clear cross-sectional area of the opening (14) being smaller than the external diameter of the armature shaft (2); pressing of the armature cores (12) onto the armature shaft (2) in the axial direction (16) of the armature shaft (2) with the at least one projection (20) sinking into the surface of the plastic (10)

The invention relates to a method for mounting a laminated armature core onto an armature shaft. Moreover, the invention relates to a laminated armature core for an armature shaft, and an armature shaft with pressed-on laminated armature core for an electric motor.

When pressing a laminated armature core onto an armature shaft, it is known to place the armature shaft into a press-cast mold with the loosely mounted laminated armature core, and to press an electrically-insulating plastic material between the armature shaft and armature laminated core. The method costs time and money, and it cannot be guaranteed to resist thermal expansion during operation of the electric motor in that a rising torque might cause the laminated armature core to rotate with respect to the armature shaft.

Even if armature cores of slightly smaller aperture dimension are pressed onto an armature shaft, a firm seat cannot be ensured for all torques, and also, this method is not proof against process failure, and is dependent on alterations to materials.

Per EP 0 299 100 A1, the armature shaft may be so deformed that it includes detents on its upper surface that engage complimentarily-formed lateral shoulder inclinations around the circumference of the aperture, thus forming a positive fit about the direction of rotation. Such a design is expensive, and it is difficult to mount the laminated armature core on the armature shaft.

In another very expensive method for insulated mounting of a laminated armature core onto an armature shaft per DE 44 32 356 A1, first a tube of deformable, electrically-insulating material is inserted into the aperture of the laminated armature core. Subsequently, the armature shaft prepared to have a slightly larger dimension than the tube is pressed into it, whereby the tube is stretched and forced into recesses of the laminated armature core where applicable.

Starting from these known methods, it is the task of the invention to provide a simple, low-cost, but reliable manufacturing process to mount a laminated armature core onto an armature shaft for an electric motor.

This task is solved by a method with the properties of patent claim 1.

The central aperture of armature cores with at least one projection is provided a dimension such that the armature cores, or a laminated armature core form of them in advance, are not loose, but rather may only be forced onto the armature shaft by pressing the projection into the surface of the plastic of the armature shaft. During this, plastic material is removed, i.e., plastic flakes or chips may be created as a result of compressing and displacing the plastic material by means of the projection or projections when the armature cores are pressed onto the armature shaft. By means of this, however, a positive fit may be simultaneously achieved in a simple fashion along the rotational direction between laminated armature core and armature shaft that may safely withstand the torque forces arising during operation. The excess plastic material thus drops away as a result of gravity upon pressing the armature cores onto the armature shaft, or it is extracted using a suitable partial-vacuum device.

At least two projections, and particularly three projections, are preferably provided that are preferably distributed evenly about the circumference.

It has proved to be particularly useful for the axially-positioned projections to gouge into the plastic to a depth of 0.05-0.4 mm, particularly from 0.1 mm-0.3 mm, and most particularly 0.1-0.25 mm.

Further, it has been shown to be advantageous if the armature cores are first assembled into a packet and then the armature core is pressed onto the armature shaft as a unit. The pressing force thus required is not significantly greater than the force required to press the first armature core onto the armature shaft.

Another subject of the invention is a laminated armature core with the properties of Claim 5.

The apertures in the armature cores (or in a laminated armature core formed of them) in the areas other than the projection(s) possess a diameter that is essentially the same as the outer diameter of the armature shaft; it is preferably very slightly less than the outer diameter of the armature shaft. For an outer diameter of the armature shaft of 5 to 15 mm, particularly from 8 to 12 mm, the diameter of the aperture of the armature cores (outside the projection) is about 5 to 10 μm less than the outer diameter of the armature shaft in order to achieve an even seat for the laminated armature core. Load-relief recesses may also be provided in the armature cores that prevent the arising of excess tension during pressing the armature cores [onto the armature shaft], or during operation of the electric motor, because of thermal expansion.

For an aperture diameter of from 5-15 mm, and preferably 8-12 mm, outside of the minimum of one projection, the laminated armature core is so formed per an advantageous embodiment [of the invention] that at least one projection extends inward radially from a concentric edge section adjacent to the aperture for 0.05-0.4 mm, particularly 0.1-0.3 mm, and most particularly 0.1-0.25 mm.

Further, it has proved to be useful for the projection projecting sharply outward possesses at its radial inner end a curvature radius of maximum 0.4 mm, particularly of maximum 0.3 mm, and most particularly of maximum 0.25 mm.

For this, the thickness of the armature cores is preferably 0.3-0.8 mm, particularly from 0.4-0.7 mm.

Further, protection is claimed for an armature shaft with pressed-on laminated armature core with the properties of Claim 9.

Further properties, details, and advantages of the invention result from the included Dependent Claims, and from the graphic representation and subsequent description of an advantageous embodiment of the invention, which show:

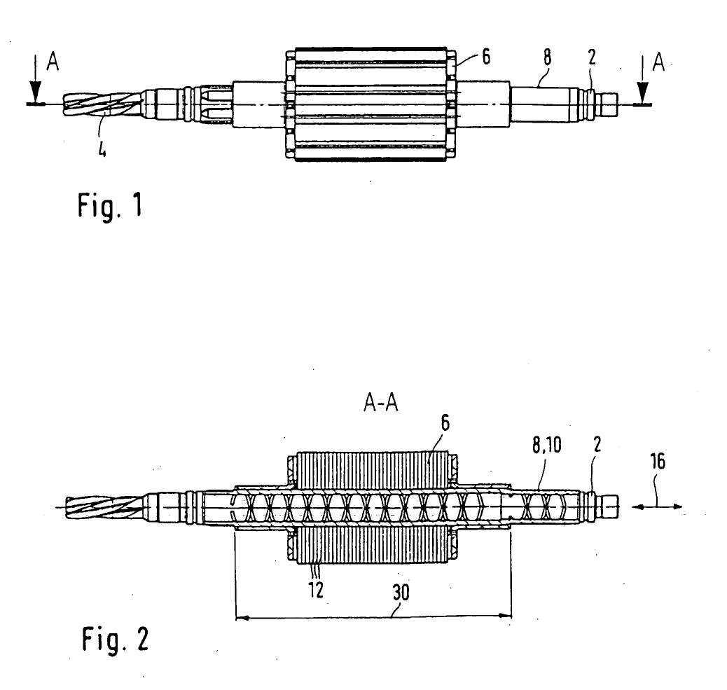

FIG. 1 lateral view of an armature shaft with pressed-on laminated armature core per the invention;

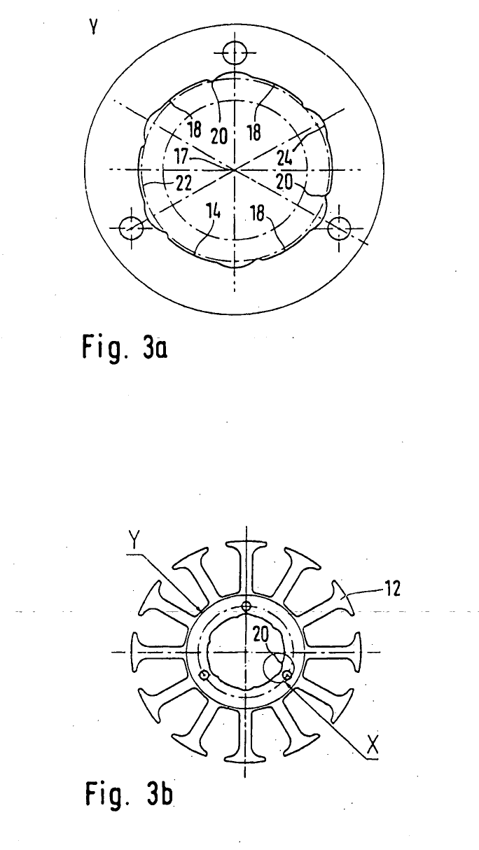

FIG. 2 longitudinal cutaway view along projection AA in FIG. 1;

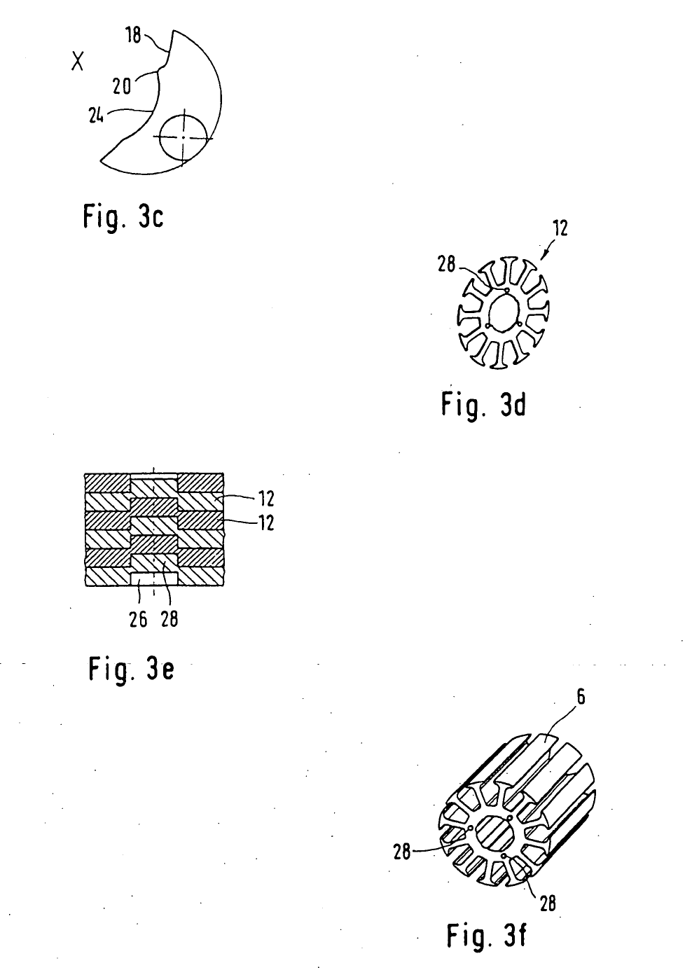

FIGS. 3a-3f various views of an armature core.

FIGS. 1 and 2 show an armature shaft 2 for an electric motor, e.g., for an electrical hand tool. The armature shaft 2 is formed on a free end section in the form of a bevel gear. Since a drive train (not shown) that connects to the bevel gear 4 extends outside of the electrical hand tool, a laminated armature core 6 is electrically insulated from the armature shaft 2. For this, the armature shaft 2 bears a mantle 8 of an electrically-insulating plastic 10: The armature shaft 2 might also be made completely of electrically-insulating plastic. The laminated armature core consists in conventional manner of a large number of armature cores 12 arranged in parallel and electrically insulated form one another. Each armature core 12 includes a central aperture 14 by means of which it is forced or pressed onto the armature shaft 2 along the axial direction 16.

FIGS. 3a through 3f show various views of an armature core 12 formed per the invention. FIGS. 3a (intended merely to show the central aperture 14) and 3b, and detailed representation per FIG. 3c show the configuration of the central aperture 14. The aperture 14 is limited by a number of edge sections 18 extending concentric to a central point 17. Six projections 20 in this illustrated case extend from these concentric edge sections 18 radially inward.

The concentric edge sections 18 define an inner diameter that in this illustrated case is only a few μm smaller than the outer diameter of the plastic-mantled armature shaft 2.

The projections 20 in the illustrated case with an aperture diameter of 10 mm extend radially inward from the concentric edge sections 18 by 0.15 mm. An inscribed circle 22 that is limited or defined by the projections 20 projecting radially inward possesses an open cross-sectional surface that in the illustrated case is 9.7 mm less in diameter than is the outer diameter of the plastic-mantled armature shaft 2, which is 10 mm.

A recess 24 is provided along with each projection 20 which provides a tension-relief pocket to prevent that peak tension within the material of the armature core 12 occur during manufacture or during operation of the electric motor. They possess no direct relation to the achievement of a firm seat of the armature cores 12 or of a laminated armature core 6 made of them during pressing onto an armature shaft 2.

FIG. 3d shows a perspective view of an armature core 12. FIG. 3e shows point-shaped affixing recesses 26 and affixing projections 28 complementary to them that are also shown in the previous Figures, and with whose help the armature cores 12 are affixed in a pre-determined mounting position with respect to one another. Finally, FIG. 3f shows a perspective view of a laminated armature core 6 made of a large number of armature cores 12.

The laminated armature core 6 is then forced onto the armature shaft 2 in an axial direction. During this, the projections 20 projecting sharply outward with curvature radius of 0.2 mm gouge into the surface of the mantle 8 of electrically insulating plastic 10. The outer diameter in the pertinent section 30 of the armature shaft 2 shown in FIG. 2 is, as mentioned above, 10 mm, so that the projections 20 with their overall radial extension over the concentric edge sections 18, i.e. gouge into the mantle by about 0.15 mm. During this, plastic 10 is ejected from the surface in flakes or chips, which fall away or are extracted using a partial-vacuum device. The result is a positive-fit coupling of the laminated armature core 6 to the armature shaft 2 that is fixed against rotation along the circumference and has no play.

1. Method for mounting a laminated armature core (6) on an armature shaft (2) for an electric motor, whereby the armature shaft (2) is made either completely of electrically-insulating plastic, or is a shaft surrounded with a mantle of electrically-insulating plastic (10), whereby the mantle (8) possesses a thickness of at least 1 mm, with the following properties:
Manufacture of armature cores (12) whose central aperture (14) for the armature shaft (2) possesses a non-round cross section with at least one radially inward extended projection (20), whereby the diameter of an inscribed circle (22) which forms a clear cross-sectional area of the aperture (14) is smaller than the external diameter of the armature shaft (2),
Pressing of the armature cores (12) onto the armature shaft (2) in the axial direction of the armature shaft (2)
characterized in that
for an aperture (14) diameter of from 5-15 mm of the armature cores, except for the minimum of one projection, the laminated armature core is so formed that at least one projection extends inward radially from a concentric edge section limiting the aperture (14) for 0.05-0.4 mm.
this minimum of one projection (20) gouges into the surface of the plastic (10) of the armature shaft (2) when pressed onto the armature shaft along the axial direction (16), thereby preventing rotation of the laminated armature core (6) on the armature shaft (2), and that the edge sections (18) limiting the aperture (14) armature cores (12) rest against the outer diameter of the armature shaft (2).

2. Method as in claim 1, characterized in that at least two projections (20) are provided that extend radially inward that gouge into the surface of the plastic (10) upon being pressed [onto the armature shaft (2)].

3. Method as in claim 1, characterized in that the projections (20) extending in the radial direction gouge into the surface of the plastic to a depth of from 0.1-0.3 mm, and particularly 0.1-0.25 mm.

4. Method as in claim 1, characterized in that armature cores (12) are first combined into a laminated armature core (6) and then the laminated armature core (6) is pressed onto the armature shaft (2).

5. Laminated armature core (6) for an armature shaft (2) completely made of electrically-insulating plastic or a shaft covered by electrically-insulating plastic (10) for an electric motor, whereby the mantle (8) possesses a thickness of at least 1 mm, with a non-round aperture for pressing [the laminated armature core] onto the armature shaft (2), characterized in that the laminated armature core (6) includes at least one projection (20) that possesses a sharp point and extends radially inward into the aperture (14); in that this projection (20) may gouge into the plastic surface of the armature shaft (2) when pressed [onto the armature shaft], thereby preventing rotation of the laminated armature core (6) on the armature shaft (2), and that for an aperture (14) diameter of from 5-15 mm of the armature cores, except for the minimum of one projection, the laminated armature core is so formed that at least one projection extends radially inward from a concentric edge section limiting the aperture (14) for 0.05-0.4 mm.

6. Laminated armature core as in claim 5, characterized in that for an outer diameter of the armature shaft of 5 to 15 mm except for the projection, particularly from 8 to 12 mm, the minimum of one projection (20 extends radially inward from a concentric edge section (18) limiting the aperture (14) by 0.1-0.3 mm, and particularly 0.1-0.25 mm.

7. Laminated armature core as in claim 5, characterized in that the pointed projection (20) possesses a curvature radius at its inner radial end of maximum 0.4 mm, particularly of maximum 0.3 mm, and most particularly of 0.25 mm.

8. Laminated armature core as in claim 5, characterized in that the thickness of the armature cores (12) is 0.3-0.8 mm, particularly 0.4-0.7 mm.

9. Armature shaft (2) with pressed-on laminated armature core (6) for an electric motor, whereby the armature shaft (2) is either made completely of electrically-insulating plastic, or is a shaft surrounded with a mantle of electrically-insulating plastic (10), whereby
the mantle (8) possesses a thickness of at least 1 mm;
the laminated armature core (6) is formed with a non-round aperture (14) for the purpose of pressing [the laminated armature core] onto the armature shaft (2); characterized in that
at least one projection point is formed, and
this projection (20) gouges into the plastic surface of the armature shaft (2) radially inward to a depth of 0.05-0.4 mm during pressing onto it, thereby preventing the laminated armature core (6) from rotating with respect to the armature shaft (2), and
for an aperture (14) diameter of from 5-15 mm of the armature cores, except for the minimum of one projection, the laminated armature core is so formed that at least one projection extends radially inward from a concentric edge section limiting the aperture (14) for 0.05-0.4 mm,
the laminated armature core (6) possesses at least one pointed projection (20) extending radially inward into the aperture (14); and that
the edge sections (18) limiting the aperture (14) armature cores (12) rest against the outer diameter of the armature shaft (2).

10. Armature shaft with pressed-on laminated armature core (6) as in claim 9, characterized in that the mantle possesses a thickness of at least 1.2 mm.

11. Method as in claim 2, characterized in that the projections (20) extending in the radial direction gouge into the surface of the plastic to a depth of from 0.1-0.3 mm, and particularly 0.1-0.25 mm.

12. Method as in claim 2, characterized in that armature cores (12) are first combined into a laminated armature core (6) and then the laminated armature core (6) is pressed onto the armature shaft (2).

13. Method as in claim 3, characterized in that armature cores (12) are first combined into a laminated armature core (6) and then the laminated armature core (6) is pressed onto the armature shaft (2).

14. Laminated armature core as in claim 6, characterized in that the pointed projection (20) possesses a curvature radius at its inner radial end of maximum 0.4 mm, particularly of maximum 0.3 mm, and most particularly of 0.25 mm.

15. Laminated armature core as in claim 6, characterized in that the thickness of the armature cores (12) is 0.3-0.8 mm, particularly 0.4-0.7 mm.

16. Laminated armature core as in claim 7, characterized in that the thickness of the armature cores (12) is 0.3-0.8 mm, particularly 0.4-0.7 mm.
